(19) United States
(12) Patent Application Publication
(10) Pub. No.: US 2006/0120454 A1
(43) Pub. Date: Jun. 8, 2006

(54) Method and apparatus for encoding/decoding video signal using motion vectors of pictures in base layer

(76) Inventors: Seung Wook Park, Sungnam-si (KR); Ji Ho Park, Sungnam-si (KR); Byeong Moon Jeon, Sungnam-si (KR)

Correspondence Address: HARNESS, DICKEY & PIERCE, P.L.C., P.O. BOX 8910, RESTON, VA, 20195, US

(21) Appl. No.: 11/288,160

(22) Filed: Nov. 29, 2005

Related U.S. Application Data
(60) Provisional application No. 60/631,177, filed on Nov. 29, 2004.
(60) Provisional application No. 60/643,162, filed on Jan. 13, 2005.
(60) Provisional application No. 60/648,422, filed on Feb. 1, 2005.

(30) Foreign Application Priority Data
Mar. 30, 2005 (KR) 10-2005-0026796
Mar. 30, 2005 (KR) 10-2005-0026780

(51) Int. Cl. H04N 11/02; H04N 11/04; H04N 7/12; H04B 1/66

(52) U.S. Cl. 375/240.16; 375/240.24

(57) ABSTRACT

A method and apparatus for encoding video signals of a main layer using motion vectors of predictive image frames of an auxiliary layer and decoding such encoded video data is provided. In the encoding method, a video signal is encoded in a scalable MCTF scheme to output an enhanced layer (EL) bitstream and encoded in another specified scheme to output a base layer (BL) bitstream. During MCTF encoding, information regarding a motion vector of an image block in an arbitrary frame in a frame sequence of the video signal is recorded using a motion vector of a block, which is present, at a position corresponding to the image block, in an auxiliary frame present in the BL bitstream and temporally separated from the arbitrary frame. Using the correlation between motion vectors of temporally adjacent frames in different layers reduces the amount of coded motion vector data.

### PRIORITY INFORMATION

This application claims priority under 35 U.S.C. §119 on Korean Patent Application No. 10-2005-0026796, filed on Mar. 30, 2005, and Korean Patent Application No. 10-2005-0026780, filed on Mar. 30, 2005, the entire contents of which are hereby incorporated by reference.

This application also claims priority under 35 U.S.C. §119 on U.S. Provisional Application No. 60/631,177, filed on Nov. 29, 2004; U.S. Provisional Application No. 60/643,162, filed on Jan. 13, 2005, and U.S. Provisional Application No. 60/648,422. filed on Feb. 1, 2005, the entire contents of which are hereby incorporated by reference.

### BACKGROUND OF THE INVENTION

1. Field of the Invention

The present invention relates to scalable encoding and decoding of video signals, and more particularly to a method and apparatus for encoding a video signal in a scalable Motion Compensated Temporal Filtering (MCTF) scheme using motion vectors of pictures of a base layer, and a method and apparatus for decoding such encoded video data.

2. Description of the Related Art

It is difficult to allocate high bandwidth, required for TV signals, to digital video signals wirelessly transmitted and received by mobile phones and notebook computers, which are widely used, and by mobile TVs and handheld PCs, which it is believed will come into widespread use in the future. Thus, video compression standards for use with mobile devices must have high video signal compression efficiencies.

Such mobile devices have a variety of processing and presentation capabilities so that a variety of compressed video data forms must be prepared. This indicates that the same video source must be provided in a variety of forms corresponding to a variety of combinations of a number of variables such as the number of frames transmitted per second, resolution, and the number of bits per pixel. This imposes a great burden on content providers.

Because of these facts, content providers prepare high-bitrate compressed video data for each source video and perform, when receiving a request from a mobile device, a process of decoding compressed video and encoding it back into video data suited to the video processing capabilities of the mobile device before providing the requested video to the mobile device. However, this method entails a transcoding procedure including decoding and encoding processes, which causes some time delay in providing the requested data to the mobile device. The transcoding procedure also requires complex hardware and algorithms to cope with the wide variety of target encoding formats.

The Scalable Video Codec (SVC) has been developed in an attempt to overcome these problems. This scheme encodes video into a sequence of pictures with the highest image quality while ensuring that part of the encoded picture sequence (specifically, a partial sequence of frames intermittently selected from the total sequence of frames) can be decoded and used to represent the video with a low image quality. Motion Compensated Temporal Filtering (MCTF) is an encoding scheme that has been suggested for use in the scalable video codec.

Although it is possible to represent low image-quality video by receiving and processing part of the sequence of pictures encoded in the scalable MCTF coding scheme as described above, there is still a problem in that the image quality is significantly reduced if the bitrate is lowered. One solution to this problem is to provide an auxiliary picture sequence for low bitrates, for example, a sequence of pictures that have a small screen size and/or a low frame rate.

The auxiliary picture sequence is referred to as a base layer, and the main frame sequence is referred to as an enhanced or enhancement layer. Video signals of the base and enhanced layers have redundancy since the same video signal source is encoded into the two layers. To increase the coding efficiency of the enhanced layer according to the MCTF scheme, one method converts each video frame of the enhanced layer into a predictive image based on a video frame of the base layer temporally coincident with the enhanced layer video frame. Another method codes motion vectors of a picture in the enhanced layer using motion vectors of a picture in the base layer temporally coincident with the enhanced layer picture. FIG. 1 illustrates how a picture in the enhanced layer is coded using motion vectors of a temporally coincident picture in the base layer.

The motion vector coding method illustrated in FIG. 1 is performed in the following manner. If the screen size of frames in the base layer is less than the screen size of frames in the enhanced layer, a base layer frame F1 temporally coincident with a current enhanced layer frame F10, which is to be converted into a predictive image, is enlarged to the same size as the enhanced layer frame. Here, motion vectors of macroblocks in the base layer frame are also scaled up by the same ratio as the enlargement ratio of the base layer frame.

A motion vector mv1 of each macroblock MB10 in the enhanced layer frame F10 is determined through motion estimation. The motion vector mv1 is compared with a motion vector mvScaledBL1 obtained by scaling up a motion vector mvBL1 of a macroblock MB1 in the base layer frame F1, which covers an area in the base layer frame F1 corresponding to the macroblock MB10. If both the enhanced and base layers use macroblocks of the same size (for example, 16×16 macroblocks), a macroblock in the base layer covers a larger area in a frame than a macroblock in the enhanced layer. The motion vector mvBL1 of the macroblock MB1 in the base layer frame F1 is determined by a base layer encoder before the enhanced layer is encoded.

If the two motion vectors mv1 and mvScaledBL1 are identical, a value indicating that the motion vector mv1 of the macroblock MB10 is identical to the scaled motion vector mvScaledBL1 of the corresponding block MB1 in the base layer is recorded in a block mode of the macroblock MB10. If the two motion vectors mv1 and mvScaledBL1 are different, the difference between the two motion vectors mv1 and mvScaledBL1 are coded, provided that coding of the vector difference (i.e., mv1−mvScaledBL1) is advantageous over coding of the motion vector mv1. This reduces the amount of vector data to be coded in the enhanced layer coding procedure.

However, since the base and enhanced layers are encoded at different frame rates, many frames in the enhanced layer have no temporally coincident frames in the base layer. For example, an enhanced layer frame (Frame B) shown in FIG. 1 has no temporally coincident frame in the base layer. The above methods for increasing the coding efficiency of the enhanced layer cannot be applied to the frame (Frame B) since it has no temporally coincident frame in the base layer.

However, enhanced and base layer frames, which have a short time interval therebetween although they are not temporally coincident, will be likely to be correlated with each other in the motion estimation since they are temporally close to each other. This indicates that, even for enhanced layer frames having no temporally coincident base layer frames, it is possible to increase the coding efficiency using motion vectors of base layer frames temporally close to the enhanced layer frames since the temporally close enhanced and base layer frames are likely to have similar motion vectors.

### SUMMARY OF THE INVENTION

Therefore, the present invention has been made in view of the above problems, and it is an object of the present invention to provide a method and apparatus for encoding video signals in a scalable scheme using motion vectors of base layer pictures temporally separated from pictures which are to be encoded into predictive images.

It is another object of the present invention to provide a method and apparatus for decoding pictures in a data stream of the enhanced layer, which have image blocks encoded using motion vectors of base layer pictures temporally separated from the enhanced layer pictures.

It is yet another object of the present invention to provide a method and apparatus for deriving motion vectors of a predictive image from motion vectors of the base layer when encoding the video signal into the predictive image or when decoding the predictive image into the video signal in a scalable scheme.

In accordance with the present invention, the above and other objects can be accomplished by the provision of a method and apparatus for encoding/decoding a video signal, wherein the video signal is encoded in a scalable MCTF scheme to output a bitstream of a first layer while the video signal is encoded in another specified scheme to output a bitstream of a second layer, and, when encoding is performed in the MCTF scheme, information regarding a motion vector of an image block in an arbitrary frame present in the video signal is recorded using information based on a motion vector of a block present in an auxiliary frame at a position corresponding to the image block, the auxiliary frame being present in the bitstream of the second layer and temporally separated from the arbitrary frame.

In an embodiment of the present invention, information regarding a motion vector of an image block in an arbitrary frame present in the first layer is recorded using a motion vector of a block present in an auxiliary frame in the second layer, the auxiliary frame having a predictive image and being temporally closest to the arbitrary frame of the first layer.

In an embodiment of the present invention, information regarding a motion vector of a current image block in the arbitrary frame is recorded using information based on a motion vector of a block in an auxiliary frame if use of the motion vector of the block in the auxiliary frame is advantageous in terms of the amount of information.

In an embodiment of the present invention, the information regarding the motion vector of the current image block is recorded using information indicating that the motion vector of the current image block is identical to a vector derived from the motion vector of the block in the auxiliary frame. Hereinafter, the derived vector is also referred to as a “derivative vector”.

In an embodiment of the present invention, the information regarding the motion vector of the current image block is recorded using a difference vector between the derivative vector, derived from the motion vector of the block in the auxiliary frame, and an actual motion vector from the current image block to its reference block.

In an embodiment of the present invention, the screen size of auxiliary frames of the second layer is less than the screen size of frames of the first layer.

In an embodiment of the present invention, the derivative vector is derived using a vector obtained by scaling the motion vector of the block in the auxiliary frame by the ratio (i.e., the resolution ratio) of the screen size of frames in the first layer to the screen size of auxiliary frames in the second layer and multiplying the scaled motion vector by a derivation factor.

In another embodiment of the present invention, the derivative vector is derived using a vector obtained by multiplying the motion vector of the block in the auxiliary frame by a derivation factor and scaling the multiplied motion vector by the ratio of the screen size of frames in the first layer to the screen size of auxiliary frames in the second layer.

In these embodiments, the derivation factor is defined as the ratio of a time interval between the arbitrary frame and a frame, present downstream of the arbitrary frame in a target derivative vector direction of the image block, to a time interval between the auxiliary frame and another auxiliary frame including a block indicated by the motion vector of the block in the auxiliary frame.

### BRIEF DESCRIPTION OF THE DRAWINGS

The above and other objects, features and other advantages of the present invention will be more clearly understood from the following detailed description taken in conjunction with the accompanying drawings, in which:

FIG. 1 illustrates how a picture in the enhanced layer is coded using motion vectors of a temporally coincident picture in the base layer;

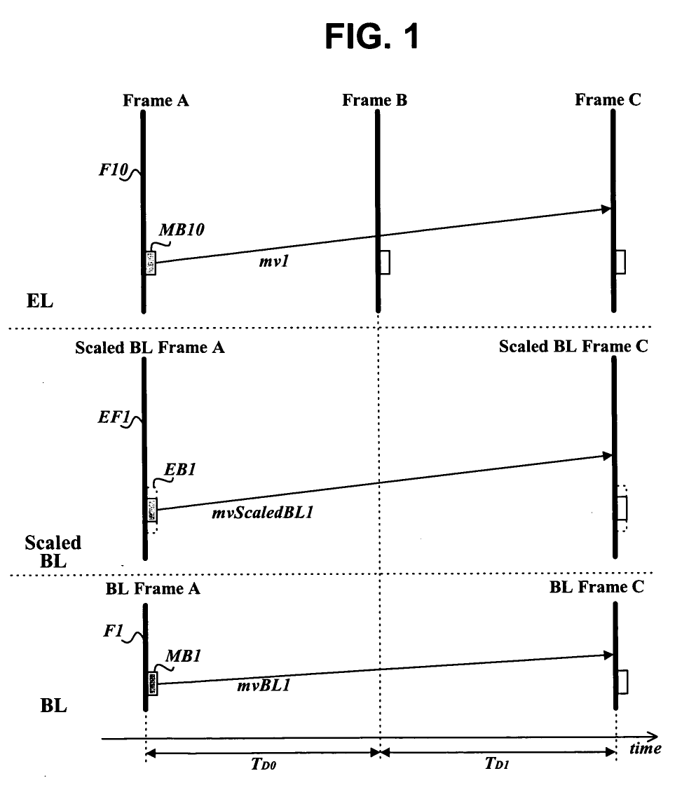

FIG. 2 is a block diagram of a video signal encoding apparatus to which a video signal coding method according to the present invention is applied;

FIG. 3 is a block diagram of part of a filter responsible for performing image estimation/prediction and update operations in an MCTF encoder of FIG. 2;

FIGS. 4a and 4b illustrate how a motion vector of a target macroblock in an enhanced layer frame to be coded into a predictive image is determined using a motion vector of a base layer frame temporally separated from the enhanced layer frame according to the present invention;

FIG. 5 is a block diagram of an apparatus for decoding a data stream encoded by the apparatus of FIG. 2; and

FIG. 6 is a block diagram of part of an inverse filter responsible for performing inverse prediction and update operations in an MCTF decoder of FIG. 5.

### DETAILED DESCRIPTION OF PREFFERRED EMBODIMENTS

Preferred embodiments of the present invention will now be described in detail with reference to the accompanying drawings.

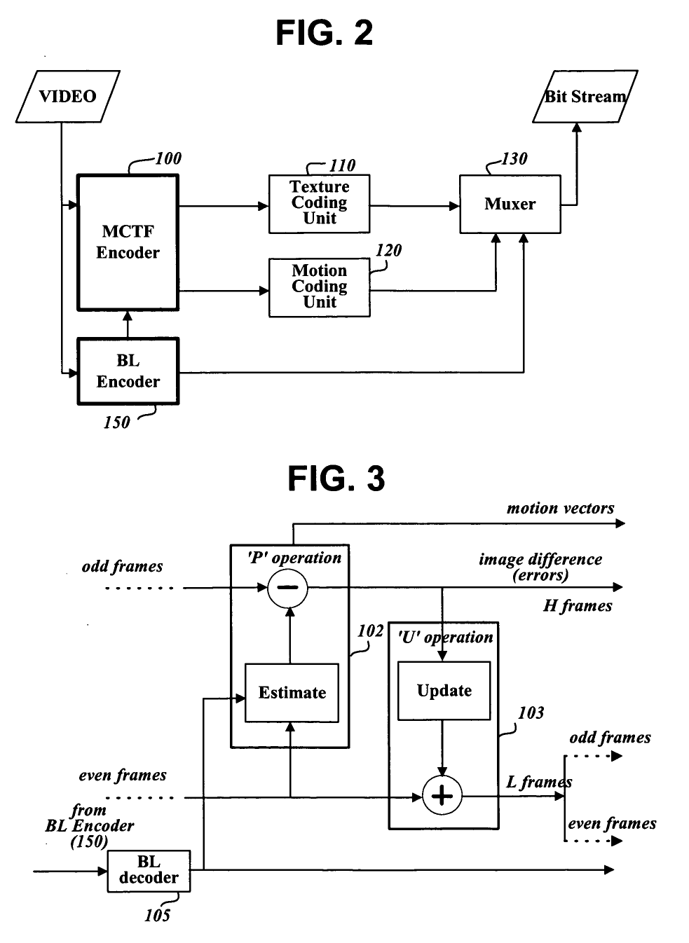

FIG. 2 is a block diagram of a video signal encoding apparatus to which a scalable video signal coding method according to the present invention is applied.

The video signal encoding apparatus shown in FIG. 2 comprises an MCTF encoder 100, a texture coding unit 110, a motion coding unit 120, a base layer encoder 150, and a muxer (or multiplexer) 130. The MCTF encoder 100 encodes an input video signal in units of macroblocks in an MCTF scheme, and generates suitable management information. The texture coding unit 110 converts information of encoded macroblocks into a compressed bitstream. The motion coding unit 120 codes motion vectors of image blocks obtained by the MCTF encoder 100 into a compressed bitstream according to a specified scheme. The base layer encoder 150 encodes an input video signal according to a specified scheme, for example, according to the MPEG-1, 2 or 4 standard or the H.261, H.263 or H.264 standard, and produces a small-screen picture sequence, for example, a sequence of pictures scaled down to 25% of their original size. The muxer 130 encapsulates the output data of the texture coding unit 110, the picture sequence output from the base layer encoder 150, and the output vector data of the motion coding unit 120 into a predetermined format. The muxer 130 then multiplexes and outputs the encapsulated data into a predetermined transmission format. The base layer encoder 150 can provide a low-bitrate data stream not only by encoding an input video signal into a sequence of pictures having a smaller screen size than pictures of the enhanced layer but also by encoding an input video signal into a sequence of pictures having the same screen size as pictures of the enhanced layer at a lower frame rate than the enhanced layer. In the embodiments of the present invention described below, the base layer is encoded into a small-screen picture sequence.

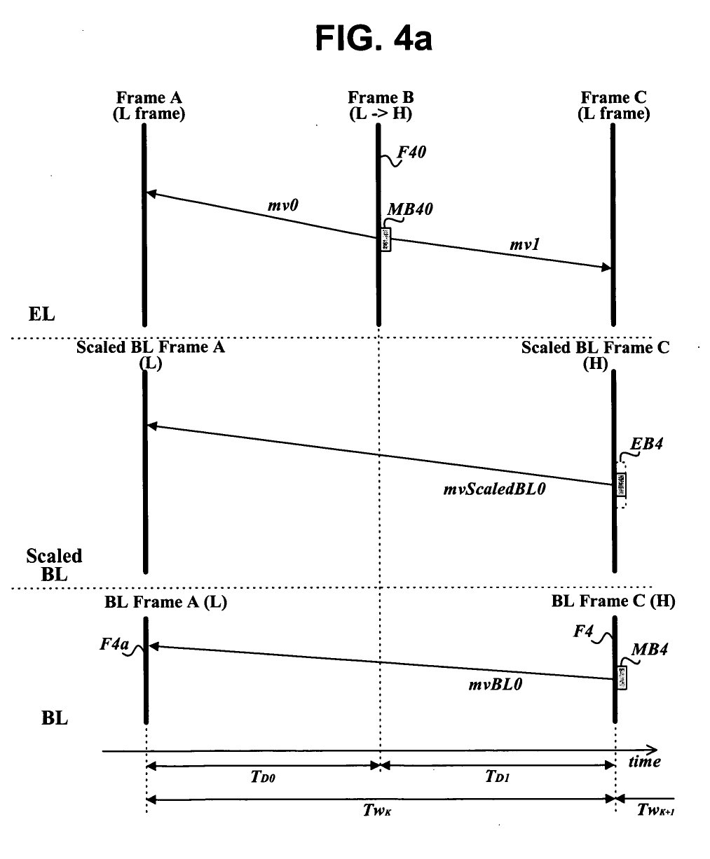

The MCTF encoder 100 performs motion estimation and prediction operations on each target macroblock in a video frame. The MCTF encoder 100 also performs an update operation on each target macroblock by adding an image difference of the target macroblock from a corresponding macroblock in a neighbor frame to the corresponding macroblock in the neighbor frame. FIG. 3 is a block diagram of part of a filter that performs these operations.

The MCTF encoder 100 separates an input video frame sequence into odd and even frames and then performs estimation/prediction and update operations on a certain-length sequence of pictures, for example, on a Group Of Pictures (GOP), a plurality of times until the number of L frames, which are produced by the update operation, is reduced to one. FIG. 3 shows elements associated with estimation/prediction and update operations at one of a plurality of MCTF levels.

The elements of FIG. 3 include an estimator/predictor 102, an updater 103, and a base layer (BL) decoder 105. The BL decoder 105 functions to extract a motion vector of each motion-estimated (inter-frame mode) macroblock from a stream encoded by the base layer encoder 150 and also to scale up the motion vector of each motion-estimated macroblock by the upsampling ratio required to restore the sequence of small-screen pictures to their original image size. Through motion estimation, the estimator/predictor 102 searches for a reference block of each target macroblock of a current frame, which is to be coded to residual data, in a neighbor frame prior to or subsequent to the current frame, and codes an image difference (i.e., a pixel-to-pixel difference) of the target macroblock from the reference block. The estimator/predictor 102 directly calculates a motion vector of the target macroblock with respect to the reference block or generates information which uses a motion vector of a corresponding block scaled by the BL decoder 105. The updater 103 performs an update operation on a macroblock, whose reference block has been found by the motion estimation, by multiplying the image difference of the macroblock by an appropriate constant (for example, ½ or ¼) and adding the resulting value to the reference block. The operation carried out by the updater 103 is referred to as a ‘U’ operation, and a frame produced by the ‘U’ operation is referred to as an ‘L’ frame.

The estimator/predictor 102 and the updater 103 of FIG. 2 may perform their operations on a plurality of slices, which are produced by dividing a single frame, simultaneously and in parallel instead of performing their operations on the video frame. A frame (or slice) having an image difference (i.e., a predictive image), which is produced by the estimator/predictor 102, is referred to as an ‘H’ frame (or slice) since the difference value data in the ‘H’ frame (or slice) reflects high frequency components of the video signal. In the following description of the embodiments, the term ‘frame’ is used in a broad sense to include a ‘slice’, provided that replacement of the term ‘frame’ with the term ‘slice’ is technically equivalent.

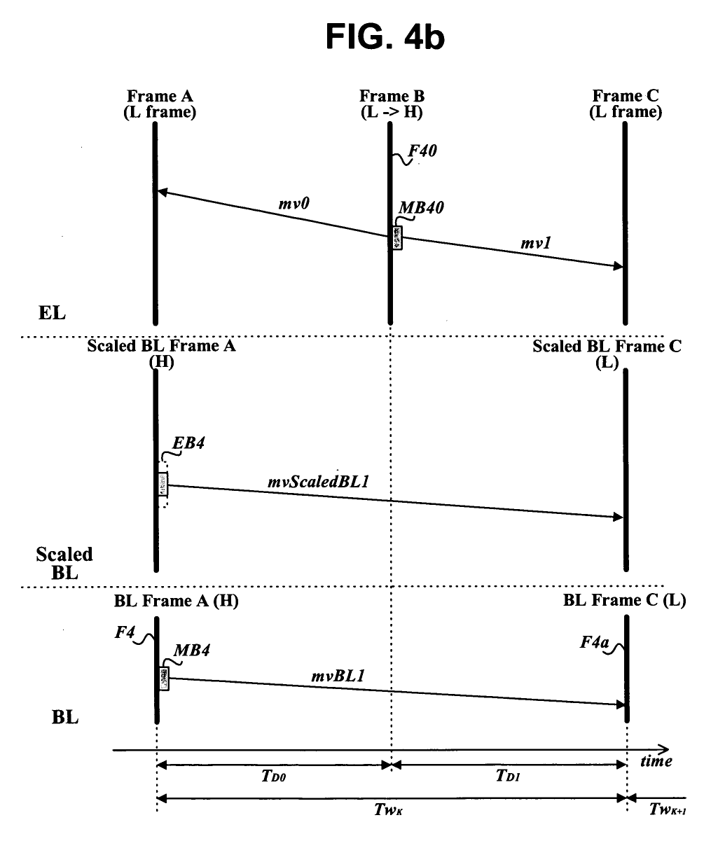

More specifically, the estimator/predictor 102 divides each of the input video frames (or each L frame obtained at the previous level) into macroblocks of a predetermined size. The estimator/predictor 102 codes each target macroblock of an input video frame through inter-frame motion estimation. The estimator/predictor 102 directly determines a motion vector of the target macroblock. Alternatively, if a temporally coincident frame is present in the enlarged base layer frames received from the BL decoder 105, the estimator/predictor 102 records, in an appropriate header area, information which allows the motion vector of the target macroblock to be determined using a motion vector of a corresponding block in the temporally coincident base layer frame. A detailed description of this procedure is omitted since it is known in the art and is not directly related to the present invention. Instead, example procedures for determining motion vectors of macroblocks in an enhanced layer frame using motion vectors of a base layer frame temporally separated from the enhanced layer frame according to the present invention will now be described in detail with reference to FIGS. 4a and 4b.

In the example of FIG. 4a, a frame (Frame B) F40 is a current frame to be encoded into a predictive image frame (H frame), and a base layer frame (Frame C) is a coded predictive frame in a frame sequence of the base layer. If a frame temporally coincident with the current enhanced layer frame F40, which is to be converted into a predictive image, is not present in the frame sequence of the base layer, the estimator/predictor 102 searches for a predictive frame (i.e., Frame C) in the base layer, which is temporally closest to the current frame F40. Practically, the estimator/predictor 102 searches for information regarding the predictive frame (Frame C) in encoding information received from the BL decoder 105.

In addition, for a target macroblock MB40 in the current frame F40 which is to be converted into a predictive image, the estimator/predictor 102 searches for a macroblock most highly correlated with the target macroblock MB40 in adjacent frames prior to and/or subsequent to the current frame, and codes an image difference of the target macroblock MB40 from the found macroblock. Such an operation of the estimator/predictor 102 is referred to as a ‘P’ operation. The block most highly correlated with a target block is a block having the smallest image difference from the target block. The image difference of two image blocks is defined, for example, as the sum or average of pixel-to-pixel differences of the two image blocks. The block having the smallest image difference is referred to as a reference block. One reference block may be present in each of the reference frames and thus a plurality of reference blocks may be present for each target macroblock.

For example, if two reference blocks of the target macroblock MB40 are found in the prior and subsequent frames and thus the target macroblock MB40 is assigned a bidirectional (Bid) mode as shown in FIG. 4a, the estimator/predictor 102 derives two motion vectors mv0 and mv1 originating from the target macroblock MB40 extending to the two reference blocks using a motion vector mvBL0 of a corresponding block MB4 in a predictive frame F4 in the base layer, which is temporally closest to the current frame F40. The corresponding block MB4 is a block in the predictive frame F4 which would have an area EB4 covering a block having the same size as the target macroblock MB40 when the predictive frame F4 is enlarged to the same size of the enhanced layer frame. Motion vectors of the base layer are determined by the base layer encoder 150, and the motion vectors are carried in a header of each macroblock and a frame rate is carried in a GOP header. The BL decoder 105 extracts necessary encoding information, which includes a frame time, a frame size, and a block mode and motion vector of each macroblock, from the header, without decoding the encoded video data, and provides the extracted information to the estimator/predictor 102.

The estimator/predictor 102 receives the motion vector mvBL0 of the corresponding block MB4 from the BL decoder 105, and scales up the received motion vector mvBL0 by the ratio of the screen size of enhanced layer frames to the screen size of base layer frames, and calculates derivative vectors mv0′ and mv1′ corresponding to motion vectors (for example, mv0 and mv1) determined for the target macroblock MB40 by Equations (1a) and (1b).
mv0′=mvScaledBL0×T_{D0}/(T_{D0}+T_{D1}) (1a)
mv1′=−mvScaledBL0×T_{D1}/(T_{D0}+T_{D1}) (1b)

Here, “T_{D1}” and “T_{D0}” denote time differences between the current frame F40 and two base layer frames (i.e., the predictive frame F4 temporally closest to the current frame F40 and a reference frame F4a of the predictive frame F4).

Equations (1a) and (1b) obtain two sections mv0′ and mv1′ of the scaled motion vector mvScaledBL0 which are respectively in proportion to the two time differences TD0 and TD1 of the current frame F40 to the two reference frames (or reference blocks) in the enhanced layer. If a target vector to be derived (“mv1” in the example of FIG. 4a) and the scaled motion vector mvScaledBL0 of the corresponding block are in opposite directions, the estimator/predictor 102 obtains a derivative vector mv1′ by multiplying the product of the scaled motion vector mvScaledBL0 and the time difference ratio T_{D1}/(T_{D0}+T_{D1}) by −1 as expressed in Equation (1b).

If the derivative vectors mv0′ and mv1′ obtained in this manner are identical to the actual motion vectors mv0 and mv1 which have been directly determined, the estimator/predictor 102 merely records information indicating that the motion vectors of the target macroblock MB40 are identical to the derivative vectors, in the header of the target macroblock MB40, without transferring the actual motion vectors mv0 and mv1 to the motion coding unit 120. That is, the motion vectors of the target macroblock MB40 are not coded in this case.

If the derivative vectors mv0′ and mv1′ are different from the actual motion vectors mv0 and mv1 and if coding of the difference vectors mv0−mv0′ and mv1−mv1′ between the actual vectors and the derivative vectors is advantageous over coding of the actual vectors mv0 and mv1 in terms of, for example, the amount of data, the estimator/predictor 102 transfers the difference vectors to the motion coding unit 120 so that the difference vectors are coded by the motion coding unit 120, and records information, which indicates that the difference vectors between the actual vectors and the vectors derived from the base layer are coded, in the header of the target macroblock MB40. If coding of the difference vectors mv0−mv0′ and mv1−mv1′ is disadvantageous, the actual vectors mv0 and mv1, which have been previously obtained, are coded.

Only one of the two frames F4 and F4a in the base layer temporally closest to the current frame F40 is a predictive frame. This indicates that there is no need to carry information indicating which one of the two neighbor frames in the base layer has the motion vectors used to encode motion vectors of the current frame F40 since a base layer decoder can specify the predictive frame in the base layer when performing decoding. Accordingly, the information indicating which base layer frame has been used is not encoded when the value indicating derivation from motion vectors in the base layer is recorded and carried in the header.

In the example of FIG. 4b, a frame (Frame B) F40 is a current frame to be encoded into a predictive image, and a base layer frame (Frame A) is a coded predictive frame in a frame sequence of the base layer. In this example, the direction of a scaled motion vector mvScaledBL1 of a corresponding block MB4, which is to be used to derive motion vectors of a target macroblock MB40, is opposite to that of the example of FIG. 4a. Accordingly, Equations (1a) and (1b) used to derive the motion vectors in the example of FIG. 4a are replaced with Equations (2a) and (2b).
mv0′==mvScaledBL1×T_{D0}/(T_{D0}+T_{D1}) (2a)
mv1′=mvScaledBL1×T_{D1}/(T_{D0}+T_{D1}) (2b)

Meanwhile, the corresponding block MB4 in the predictive frame F4 in the base layer, which is temporally closest to the current frame F40 to be coded into a predictive image, may have a unidirectional (Fwd or Bwd) mode rather than the bidirectional (Bid) mode. If the corresponding block MB4 has a unidirectional mode, the corresponding block MB4 may have a motion vector that spans a time interval other than the time interval TWK between adjacent frames (Frame A and Frame C) prior to and subsequent to the current frame F40. For example, if the corresponding block MB4 in the base layer has a backward (Bwd) mode in the example of FIG. 4a, the corresponding block MB4 may have a vector that spans only the next time interval Tw_{K+1}. Also in this case, Equations (1a) and (1b) or Equations (2a) and (2b) may be used to derive motion vectors of the target macroblock MB40 in the current frame F40.

Specifically, when “mvBL0i” denotes a vector of the corresponding block MB4, which spans the next time interval TW_{K+1}, and “mvScaledBL0i” denotes a scaled vector of the vector mvBL0i, “−mvScaledBL0i”, instead of “mvScaledBL”, is substituted into Equation (1a) in the example of FIG. 4a to obtain a target derivative vector mv0′ (i.e., mv0′=−mvScaledBL0i×T_{D0}/(T_{D0}+T_{D1})) since the target derivative vector mv0′ and the scaled vector mvScaledBL0i are in opposite directions. On the other hand, “−mvScaledBL0i” is multiplied by −1 in Equation (1b) to obtain the target derivative vector mv1′ (i.e., mv1′=−1×(−mvScaledBL0i)×T_{D1}/(T_{D0}+T_{D1})=mvScaledBL0i×T_{D1}/(T_{D0}+T_{D1})) since the target derivative vector mv1′ and the scaled vector mvScaledBL0i are in the same direction.

The two resulting equations are identical to Equations (2a) and (2b).

Similarly, if the corresponding block MB4 in the frame (Frame A) in the base layer has a forward (Fwd) mode rather than the bidirectional mode in the example of FIG. 4b, the target derivative vectors can be obtained by substituting a scaled vector of the motion vector of the corresponding block MB4 into Equations (1a) and (1b).

Thus, even if the corresponding block in the base layer has no motion vector in the same time interval as the time interval between the adjacent frames prior to and subsequent to the current frame in the enhanced layer, motion vectors of the target macroblock in the current frame can be derived using the motion vector of the corresponding block if Equations (1a) and (1b) or Equations (2a) and (2b) are appropriately selected and used taking into account the direction of the motion vector of the corresponding block in the base layer.

Instead of scaling up the motion vector in the base layer and multiplying the scaled, motion vector by the time difference ratio T_{D0}/(T_{D0}+T_{D1}) or T_{D1}/(T_{D0}+T_{D1}) as in Equations (1a) and (1b) or Equations (2a) and (2b), it is also possible to first multiply the motion vector in the base layer by the time difference ratio T_{D0}/(T_{D0}+T_{D1}) or T_{D1}/(T_{D0}+T_{D1}) and then scale up the multiplied motion vector to obtain a derivative vector of the target macroblock in the enhanced layer.

The method, in which the motion vector of the base layer is scaled up and then multiplied by the time difference ratio, is advantageous in terms of the resolution of derivative vectors. For example, if the size of a base layer picture is 25% that of an enhanced layer picture and each of the enhanced and base layer frames has the same time difference from its two adjacent frames, scaling of the motion vector of the base layer is multiplication of each component of the motion vector by 2, and multiplication by the time difference ratio is division by 2. Accordingly, the method, in which the motion vector of the base layer is scaled up and then multiplied by the time difference ratio, can obtain derivative vectors whose components are odd numbers, whereas the method, in which the motion vector of the base layer is scaled up (for example, multiplied by 2) after being multiplied by the time difference ratio (for example, divided by 2), cannot obtain derivative vectors whose components are odd numbers due to truncation in the division. Thus, it is more preferable to use the method in which the motion vector of the base layer is scaled up and then multiplied by the time difference ratio.

A data stream including L and H frames encoded in the method described above is transmitted by wire or wirelessly to a decoding apparatus or is delivered via recording media. The decoding apparatus restores the original video signal in the enhanced and/or base layer according to the method described below.

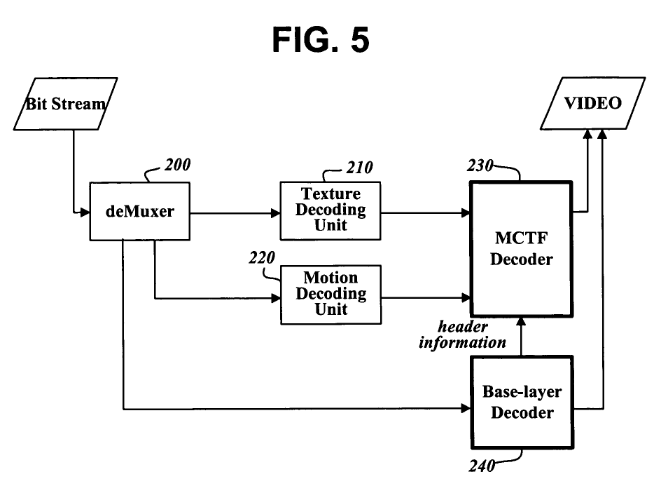

FIG. 5 is a block diagram of an apparatus for decoding a data stream encoded by the apparatus of FIG. 2. The decoding apparatus of FIG. 5 includes a demuxer (or demultiplexer) 200, a texture decoding unit 210, a motion decoding unit 220, an MCTF decoder 230, and a base layer decoder 240. The demuxer 200 separates a received data stream into a compressed motion vector stream, a compressed macroblock information stream, and a base layer stream. The texture decoding unit 210 restores the compressed macroblock information stream to its original uncompressed state. The motion decoding unit 220 restores the compressed motion vector stream to its original uncompressed state. The MCTF decoder 230 converts the uncompressed macroblock information stream and the uncompressed motion vector stream back to an original video signal according to an MCTF scheme. The base layer decoder 240 decodes the base layer stream according to a specified scheme, for example, according to the MPEG-4 or H.264 standard. The base layer decoder 240 not only decodes an input base layer stream but also provides header information in the stream to the MCTF decoder 230 to allow the MCTF decoder 230 to use necessary encoding information of the base layer, for example, information regarding the motion vector.

The MCTF decoder 230 includes therein an inverse filter for restoring an input stream to an original frame sequence.

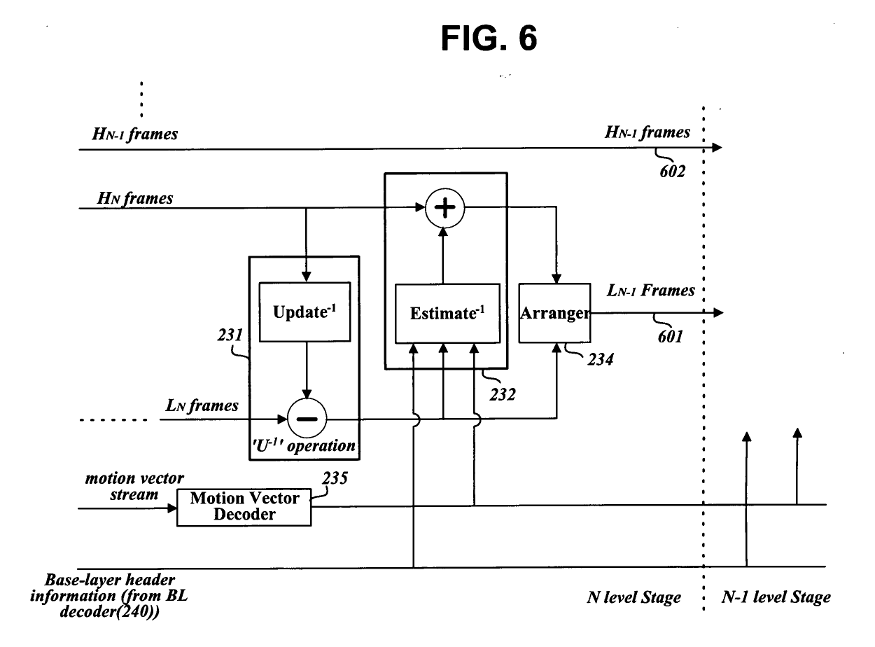

FIG. 6 is a block diagram of part of the inverse filter responsible for restoring a sequence of H and L frames of MCTF level N to an L frame sequence of MCTF level N−1. The elements of the inverse filter shown in FIG. 6 include an inverse updater 231, an inverse predictor 232, a motion vector decoder 235, and an arranger 234. The inverse updater 231 subtracts pixel difference values of input H frames from corresponding pixel values of input L frames. The inverse predictor 232 restores input H frames to L frames having original images using the H frames and the L frames, from which the image differences of the H frames have been subtracted. The motion vector decoder 235 decodes an input motion vector stream into motion vector information of macroblocks in H frames and provides the motion vector information to an inverse predictor (for example, the inverse predictor 232) of each stage. The arranger 234 interleaves the L frames completed by the inverse predictor 232 between the L frames output from the inverse updater 231, thereby producing a normal sequence of L frames.

L frames output from the arranger 234 constitute an L frame sequence 601 of level N−1. A next-stage inverse updater and predictor of level N−1 restores the L frame sequence 601 and an input H frame sequence 602 of level N−1 to an L frame sequence. This decoding process is performed the same number of times as the number of MCTF levels employed in the encoding procedure, thereby restoring an original video frame sequence.

A more detailed description will now be given of how H frames of level N are restored to L frames according to the present invention. First, for an input L frame, the inverse updater 231 subtracts error values (i.e., image differences) of macroblocks in all H frames, whose image differences have been obtained using blocks in the L frame as reference blocks, from the blocks of the L frame.

For each target macroblock of a current H frame, the inverse predictor 232 checks information regarding the motion vector of the target macroblock. If the information indicates that the motion vector of the target macroblock is identical to a derivative vector from the base layer, the inverse predictor 232 obtains a scaled motion vector mvScaledBL from a motion vector mvBL of a corresponding block in a predictive image frame (for example, an H frame), which is one of the two base layer frames temporally adjacent to the current H frame, provided from the BL decoder 240 by scaling up the motion vector mvBL by the ratio of the screen size of enhanced layer frames to the screen size of base layer frames. The inverse predictor 232 then derives the actual vector (mv=mv′) according to Equations (1a) and (1b) or Equations (2a) and (2b). If the information regarding the motion vector indicates that a difference vector from a derivative vector has been coded, the inverse predictor 232 obtains an actual motion vector mv of the target macroblock by adding a vector mv′ derived by Equations (1a) and (1b) or Equations (2a) and (2b) to the difference vector (mv−mv′) of the target macroblock provided from the motion vector decoder 235.

The inverse predictor 232 determines a reference block, present in an adjacent L frame, of the target macroblock of the current H frame with reference to the actual vector derived from the base layer motion vector or with reference to the directly coded actual motion vector, and restores an original image of the target macroblock by adding pixel values of the reference block to difference values of pixels of the target macroblock. Such a procedure is performed for all macroblocks in the current H frame to restore the current H frame to an L frame. The arranger 234 alternately arranges L frames restored by the inverse predictor 232 and L frames updated by the inverse updater 231, and provides such arranged L frames to the next stage.

To obtain the actual vector of the target macroblock, the inverse predictor 232 may multiply the motion vector mvBL in the base layer by the time difference ratio and then scale up the multiplied motion vector, instead of scaling up the motion vector mvBL in the base layer and multiplying the scaled motion vector mvScaledBL by the time difference ratio, as described above in the encoding method.

The above decoding method restores an MCTF-encoded data stream to a complete video frame sequence. In the case where the estimation/prediction and update operations have been performed for a GOP P times in the MCTF encoding procedure described above, a video frame sequence with the original image quality is obtained if the inverse prediction and update operations are performed P times, whereas a video frame sequence with a lower image quality and at a lower bitrate is obtained if the inverse prediction and update operations are performed less than P times. Accordingly, the decoding apparatus is designed to perform inverse prediction and update operations to the extent suitable for its performance.

The decoding apparatus described above can be incorporated into a mobile communication terminal or the like or into a media player.

As is apparent from the above description, a method and apparatus for encoding/decoding video signals according to the present invention has the following advantages. During MCTF encoding, motion vectors of macroblocks of the enhanced layer are coded using motion vectors of the base layer provided for low performance decoders, thereby eliminating redundancy between motion vectors of temporally adjacent frames. This reduces the amount of coded motion vector data, thereby increasing the MCTF coding efficiency.

Although this invention has been described with reference to the preferred embodiments, it will be apparent to those skilled in the art that various improvements, modifications, replacements, and additions can be made in the invention without departing from the scope and spirit of the invention. Thus, it is intended that the invention cover the improvements, modifications, replacements, and additions of the invention, provided they come within the scope of the appended claims and their equivalents.

1. A method for encoding a video signal including a frame sequence, the method comprising:
encoding the video signal in a first scheme and outputting a bitstream of a first layer; and
encoding the video signal in a second scheme and outputting a bitstream of a second layer,
the encoding in the first scheme including a process for recording information regarding a motion vector of an image block present in an arbitrary frame in the frame sequence using information based on a motion vector of a first block present in a first auxiliary frame at a position corresponding to the image block, the first auxiliary frame being present in the bitstream of the second layer and temporally separated from the arbitrary frame.

2. The method according to claim 1, wherein the arbitrary frame has no temporally coincident auxiliary frame in an auxiliary frame sequence present in the bitstream of the second layer.

3. The method according to claim 1, wherein the first auxiliary frame is a predictive image frame having image difference data and being temporally closest to the arbitrary frame from among auxiliary frames in an auxiliary frame sequence present in the bitstream of the second layer.

4. The method according to claim 1, wherein the recorded information regarding the motion vector of the image block includes a derivation factor, defined as the ratio of a time interval between the arbitrary frame and a frame, present downstream of the arbitrary frame in a target derivative vector direction of the image block, to a time interval between the first auxiliary frame and a second auxiliary frame including a block indicated by the motion vector of the first block, and information of a difference vector between the motion vector of the image block and a derivative vector derived based on the motion vector of the first block.

5. The method according to claim 4, wherein the derivative vector is obtained based on the product of a scaled motion vector, obtained by scaling the motion vector of the first block, and the derivation factor.

6. The method according to claim 5, wherein the derivative vector includes a derivative vector directed toward a frame prior to the arbitrary frame and/or a derivative vector directed toward a frame subsequent to the arbitrary frame.

7. The method according to claim 5, wherein the process includes obtaining the derivative vector based on the motion vector of the first block by multiplying the product of the scaled motion vector and the derivation factor by −1 if the motion vector of the first block and a target derivative vector direction of the image block are in different directions.

8. The method according to claim 5, wherein the scaled motion vector is obtained by scaling the motion vector of the first block by the ratio of a screen size of frames belonging to the bitstream of the first layer to a screen size of frames belonging to the bitstream of the second layer.

9. The method according to claim 1, wherein the motion vector of the first block is a vector spanning a time interval including the arbitrary frame.

10. The method according to claim 1, wherein the motion vector of the first block is a vector spanning a different time interval from a time interval including the arbitrary frame.

11. The method according to claim 1, wherein the bitstream of the second layer includes a sequence of small-screen frames having a smaller screen size than frames belonging to the bitstream of the first layer.

12. A method for receiving and decoding both a bitstream of a first layer including a sequence of H frames, each including pixels having difference values, and a sequence of L frames and a bitstream of a second layer into a video signal, the method comprising:
decoding the bitstream of the first layer into video frames having original images according to a scalable scheme using encoding information including motion vector information extracted and provided from the bitstream of the second layer,
decoding the bitstream of the first layer into the video frames including a process for obtaining a motion vector of a target block present in an arbitrary frame in the H frame sequence using a motion vector of a first block present in a first auxiliary frame at a position corresponding to the target block, the first auxiliary frame being present in the bitstream of the second layer and temporally separated from the arbitrary frame, and restoring difference values of pixels of the target block to original images based on pixel values of a reference block in an L frame, the reference block being indicated by the obtained motion vector of the target block.

13. The method according to claim 12, wherein the process includes obtaining the motion vector of the target block using the motion vector of the first block when information included in a header of the target block indicates that the motion vector of the first block is used.

14. The method according to claim 12, wherein the process includes specifying the reference block by using a derivative vector, derived from the motion vector of the first block, as the motion vector of the target block if information included in a header of the target block indicates that the derivative vector is identical to the motion vector of the target block.

15. The method according to claim 12, wherein the process includes obtaining a motion vector of the target block based on both a derivative vector, derived from the motion vector of the first block, and a difference vector and specifying the reference block using the obtained motion vector if information included in a header of the target block indicates that the difference vector is vector information of the target block.

16. The method according to claim 14, wherein the derivative vector is obtained based on both the motion vector of the first block and a derivation factor defined as the ratio of a time interval between the arbitrary frame and a frame, present downstream of the arbitrary frame in a target derivative vector direction of the target block, to a time interval between the first auxiliary frame and a second auxiliary frame including a block indicated by the motion vector of the first block.

17. The method according to claim 16, wherein the derivative vector is obtained based on the product of a scaled motion vector, obtained by scaling the motion vector of the first block, and the derivation factor.

18. The method according to claim 17, wherein the derivative vector includes a derivative vector directed toward a frame prior to the arbitrary frame and/or a derivative vector directed toward a frame subsequent to the arbitrary frame.

19. The method according to claim 17, wherein the process includes obtaining the derivative vector based on the motion vector of the first block by multiplying the product of the scaled motion vector and the derivation factor by −1 if the motion vector of the first block and a target derivative vector direction of the target block are in different directions.

20. The method according to claim 17, wherein the scaled motion vector is obtained by scaling the motion vector of the first block by the ratio of a screen size of frames belonging to the bitstream of the first layer to a screen size of frames belonging to the bitstream of the second layer.

21. The method according to claim 12, wherein the motion vector of the first block is a vector spanning a time interval including the arbitrary frame.

22. The method according to claim 12, wherein the motion vector of the first block is a vector spanning a different time interval from a time interval including the arbitrary frame.

23. An apparatus for encoding an input video signal, the apparatus comprising:
a first encoder for encoding the video signal in a first scheme and outputting a bitstream of a first layer; and
a second encoder for encoding the video signal in a second scheme and outputting a bitstream of a second layer including frames having a smaller screen size than frames in the bitstream of the first layer,
the first encoder including means for recording, in the bitstream of the first layer, information allowing a derivative vector, obtained based on the product of a derivation factor and a scaled motion vector obtained by scaling a motion vector of a first block present in the bitstream of the second layer by the ratio of a frame size of the first layer to a frame size of the second layer, to be used as a motion vector of an image block in an arbitrary frame present in the video signal and not temporally coincident with a frame including the first block.

24. The apparatus according to claim 23, wherein the frame including the first block is a predictive image frame having image difference data and being temporally closest to the arbitrary frame from among frames in a frame sequence in the second layer.

25. The apparatus according to claim 23, wherein the derivation factor is the ratio of a time interval between the arbitrary frame and a frame, present downstream of the arbitrary frame in a target derivative vector direction of the image block, to a time interval between the frame including the first block and another frame including a block indicated by the motion vector of the first block.

26. The apparatus according to claim 23, wherein the derivative vector includes a derivative vector directed toward a frame prior to the arbitrary frame and/or a derivative vector directed toward a frame subsequent to the arbitrary frame.

27. The apparatus according to claim 26, wherein the means obtains the derivative vector by multiplying the product of the scaled motion vector and the derivation factor by −1 if the motion vector of the first block and a target derivative vector direction of the image block are in different directions.

28. The apparatus according to claim 23, wherein the motion vector of the first block is a vector spanning a time interval including the arbitrary frame.

29. The apparatus according to claim 23, wherein the motion vector of the first block is a vector spanning a different time interval from a time interval including the arbitrary frame.

30. The apparatus according to claim 29, wherein the means obtains the derivative vector by multiplying the scaled motion vector of the first block by −1 to reverse a direction of the scaled motion vector and then multiplying the scaled motion vector having the reversed direction by the derivation factor.

31. A method for encoding an input video signal, the method comprising:
encoding the video signal in a first scheme and outputting a bitstream of a first layer; and
encoding the video signal in a second scheme and outputting a bitstream of a second layer including frames having a smaller screen size than frames in the bitstream of the first layer,
the encoding in the first scheme including a process for recording, in the bitstream of the first layer, information allowing a derivative vector, obtained based on the product of a derivation factor and a scaled motion vector obtained by scaling a motion vector of a first block present in the bitstream of the second layer by the ratio of a frame size of the first layer to a frame size of the second layer, to be used as a motion vector of an image block in an arbitrary frame present in the video signal and not temporally coincident with a frame including the first block.

32. The method according to claim 31, wherein the frame including the first block is a predictive image frame having image difference data and being temporally closest to the arbitrary frame from among frames in a frame sequence in the second layer.

33. The method according to claim 31, wherein the derivation factor is the ratio of a time interval between the arbitrary frame and a frame, present downstream of the arbitrary frame in a target derivative vector direction of the image block, to a time interval between the frame including the first block and another frame including a block indicated by the motion vector of the first block.

34. The method according to claim 31, wherein the derivative vector includes a derivative vector directed toward a frame prior to the arbitrary frame and/or a derivative vector directed toward a frame subsequent to the arbitrary frame.

35. The method according to claim 34, wherein the process includes obtaining the derivative vector by multiplying the product of the scaled motion vector and the derivation factor by −1 if the motion vector of the first block and a target derivative vector direction of the image block are in different directions.

36. The method according to claim 31, wherein the motion vector of the first block is a vector spanning a time interval including the arbitrary frame.

37. The method according to claim 31, wherein the motion vector of the first block is a vector spanning a different time interval from a time interval including the arbitrary frame.

38. The method according to claim 37, wherein the process includes obtaining the derivative vector by multiplying the scaled motion vector of the first block by −1 to reverse a direction of the scaled motion vector and then multiplying the scaled motion vector having the reversed direction by the derivation factor.

39. An apparatus for receiving and decoding a bitstream of a first layer including frames, each including pixels having difference values, into a video signal, the apparatus comprising:
a first decoder for decoding the bitstream of the first layer in a first scheme into video frames having original images; and
a second decoder for receiving a bitstream of a second layer including frames having a smaller screen size than the video frames, extracting encoding information including motion vector information from the received bitstream of the second layer, and providing the encoding information to the first decoder,
the first decoder including means for obtaining a motion vector of a target block in an arbitrary frame present in the bitstream of the first layer using a derivative vector obtained based on the product of a derivation factor and a scaled motion vector obtained by scaling a motion vector of a first block in a frame not temporally coincident with the arbitrary frame by the ratio of a frame size of the first layer to a frame size of the second layer, the motion vector of the first block being included in the encoding information.

40. The apparatus according to claim 39, wherein the means uses the derivative vector as the motion vector of the target block if information regarding the target block, included in the bitstream of the first layer, indicates that the derivative vector is identical to the motion vector of the target block.

41. The apparatus according to claim 39, wherein the means obtains the motion vector of the target block by calculation using the derivative vector and a difference vector if information regarding the target block, included in the bitstream of the first layer, indicates inclusion of information of the difference vector.

42. The apparatus according to claim 39, wherein the derivation factor is the ratio of a time interval between the arbitrary frame and a frame, present downstream of the arbitrary frame in a target derivative vector direction of the target block, to a time interval between the frame including the first block and another frame including a block indicated by the motion vector of the first block.

43. The apparatus according to claim 39, wherein the derivative vector includes a derivative vector directed toward a frame prior to the arbitrary frame and/or a derivative vector directed toward a frame subsequent to the arbitrary frame.

44. The apparatus according to claim 43, wherein the means obtains the derivative vector by multiplying the product of the scaled motion vector and the derivation factor by −1 if the motion vector of the first block and a target derivative vector direction of the target block are in different directions.

45. The apparatus according to claim 39, wherein the motion vector of the first block is a vector spanning a time interval including the arbitrary frame.

46. The apparatus according to claim 39, wherein the motion vector of the first block is a vector spanning a different time interval from a time interval including the arbitrary frame.

47. The apparatus according to claim 46, wherein the means obtains the derivative vector by multiplying the scaled motion vector of the first block by −1 to reverse a direction of the scaled motion vector and then multiplying the scaled motion vector having the reversed direction by the derivation factor.

48. A method for receiving and decoding a bitstream of a first layer including frames, each including pixels having difference values, into a video signal, the method comprising:
decoding the bitstream of the first layer into video frames having original images according to a scalable scheme using encoding information including motion vector information, the encoding information being extracted and provided from an input bitstream of a second layer including frames having a smaller screen size than frames in the first layer,
decoding the bitstream of the first layer into the video frames including a process for obtaining a motion vector of a target block in an arbitrary frame present in the bitstream of the first layer using a derivative vector obtained based on the product of a derivation factor and a scaled motion vector obtained by scaling a motion vector of a first block in a frame not temporally coincident with the arbitrary frame by the ratio of a frame size of the first layer to a frame size of the second layer, the motion vector of the first block being included in the encoding information.

49. The method according to claim 48, wherein the process includes using the derivative vector as the motion vector of the target block if information regarding the target block, included in the bitstream of the first layer, indicates that the derivative vector is identical to the motion vector of the target block.

50. The method according to claim 48, wherein the process includes obtaining the motion vector of the target block by calculation using the derivative vector and a difference vector if information regarding the target block, included in the bitstream of the first layer, indicates inclusion of information of the difference vector.

51. The method according to claim 48, wherein the derivation factor is the ratio of a time interval between the arbitrary frame and a frame, present downstream of the arbitrary frame in a target derivative vector direction of the target block, to a time interval between the frame including the first block and another frame including a block indicated by the motion vector of the first block.

52. The method according to claim 48, wherein the derivative vector includes a derivative vector directed toward a frame prior to the arbitrary frame and/or a derivative vector directed toward a frame subsequent to the arbitrary frame.

53. The method according to claim 52, wherein the process includes obtaining the derivative vector by multiplying the product of the scaled motion vector and the derivation factor by −1 if the motion vector of the first block and a target derivative vector direction of the target block are in different directions.

54. The method according to claim 48, wherein the motion vector of the first block is a vector spanning a time interval including the arbitrary frame.

55. The method according to claim 48, wherein the motion vector of the first block is a vector spanning a different time interval from a time interval including the arbitrary frame.

56. The method according to claim 55, wherein the process includes obtaining the derivative vector by multiplying the scaled motion vector of the first block by −1 to reverse a direction of the scaled motion vector and then multiplying the scaled motion vector having the reversed direction by the derivation factor.

57. The method according to claim 15, wherein the derivative vector is obtained based on both the motion vector of the first block and a derivation factor defined as the ratio of a time interval between the arbitrary frame and a frame, present downstream of the arbitrary frame in a target derivative vector direction of the target block, to a time interval between the first auxiliary frame and a second auxiliary frame including a block indicated by the motion vector of the first block.
